(19) United States
(12) Patent Application Publication
(10) Pub. No.: US 2017/0121191 A1
(43) Pub. Date: May 4, 2017

(54) CAPACITIVE DEIONIZATION ELECTRODE COMPRISING ACTIVATED COFFEE GROUNDS, PREPARATION METHOD THEREOF AND WATER TREATMENT DEVICE COMPRISING THE SAME

(71) Applicant: GWANGJU INSTITUTE OF SCIENCE AND TECHNOLOGY, Gwangju (KR)

(72) Inventors: Jaeyoung LEE, Gwangju (KR); Sangho CHUNG, Gwangju (KR); Jae Kwang LEE, Gwangju (KR); Haesong JEON, Gwangju (KR); Hansaem JANG, Gwangju (KR)

(21) Appl. No.: 15/338,458

(22) Filed: Oct. 31, 2016

(30) Foreign Application Priority Data
Oct. 29, 2015 (KR) 10-2015-0150635

(51) Int. Cl. C02F 1/461; C02F 1/28; C02F 1/469

(52) U.S. Cl. CPC C02F 1/46109; C02F 1/4691; C02F 1/286; C02F 2001/46133

(57) ABSTRACT

Disclosed herein are a capacitive deionization electrode including activated waste coffee grounds, a method of manufacturing the same, and a water-treatment apparatus including the same. The capacitive deionization electrode includes activated waste coffee grounds having a large specific surface area and an appropriate pore size distribution. The water-treatment apparatus includes the capacitive deionization electrode including activated waste coffee grounds, thereby exhibiting improved adsorption/desorption capacity/rate and thus excellent ion removal efficiency. The capacitive deionization electrode is manufactured using activated waste coffee grounds that have sufficiently high adsorption/desorption efficiency to replace activated carbon generally used as a material for an electrode of a typical capacitive deionization water treatment system. Thus, waste coffee grounds, which are practically used only in manufacture of aromatics/absorbents, can be used as a material for an electrode, thereby improving economics in manufacture of carbon electrodes.

### CROSS REFERENCE TO RELATED APPLICATION

This application claims the benefit of Korean Patent Application No. 10-2015-0150635, filed on Oct. 29, 2015, entitled “CAPACITIVE DEIONIZATION ELECTRODE COMPRISING ACTIVATED COFFEE GROUNDS, PREPARATION METHOD THEREOF AND WATER TREATMENT DEVICE COMPRISING THE SAME”, which is hereby incorporated by reference in its entirety into this application.

### BACKGROUND

1. Technical Field

The present invention relates to a capacitive deionization electrode including activated waste coffee grounds, a method of manufacturing the same, and a water-treatment apparatus including the same, and, more particularly, to a technique for manufacturing a capacitive deionization electrode including waste coffee grounds activated through post-treatment and for applying the same to a water-treatment apparatus.

2. Description of the Related Art

A capacitive deionization (CDI) apparatus uses capacitor effects. The capacitive deionization (CDI) apparatus can remove dissolved ions through adjustment of electrode potential and has advantages of low energy consumption and high yield rate. CDI technology can be applied to advanced water treatment (hard water and soft water treatment), ultrapure water production (production of medicines, production of semiconductors, and production of boiler feed water), saltwater desalination, resource recycling (residential water, industrial water, heavy water), and the like.

Recently, various studies on commercialization of a capacitive deionization apparatus have been made. Among these studies, research on an electrode, which is a component of such a capacitive deionization apparatus, takes much attention. A capacitive deionization system basically utilizes electrical double layer capacitor effects. Here, large specific surface area and high conductivity of an electrode material are critical factors. However, a larger specific surface area can cause reduction in adsorption/desorption efficiency, whereas a smaller specific surface area can cause reduction in overall capacitance. Thus, there is an urgent need for an electrode material having an appropriate pore size distribution.

At present, studies on production of activated carbon using various carbon sources such as palm trees, and studies on manufacture of an electrode through heat treatment and activation are made by various corporations and research groups. However, activated carbon has a problem of high cost, despite having an optimal carbon structure.

The present inventors found that waste coffee grounds activated by appropriate treatment can be used in manufacture of a capacitive deionization electrode and the electrode manufactured in this way can be applied to a water treatment apparatus, and thus have completed the present invention.

### BRIEF SUMMARY

Embodiments of the present invention have been conceived to solve such a problem in the art and it is an aspect of the present invention to provide a capacitive deionization electrode which includes activated waste coffee grounds having a large specific surface area and an appropriate pore size distribution, and a method of manufacturing the same.

It is another aspect of the present invention to provide a water-treatment apparatus which includes the capacitive deionization electrode including activated waste coffee grounds according to the invention, thereby exhibiting improved adsorption/desorption capacity/rate and thus excellent ion removal efficiency.

In accordance with one aspect of the present invention, there is provided a capacitive deionization electrode including waste coffee grounds.

The waste coffee grounds may be heat-treated waste coffee grounds.

Here, heat treatment may be performed at 600° C. to 1000° C. for 30 to 90 minutes in air.

The heat-treated waste coffee grounds may have a specific surface area of 500 m²/g to 1000 m²/g and a pore size of 1 nm to 5 nm.

In accordance with another aspect of the present invention, there is provided a water treatment apparatus including the capacitive deionization electrode including waste coffee grounds as set forth above.

In accordance with a further aspect of the present invention, there is provided a method of manufacturing a capacitive deionization electrode including activated waste coffee grounds, including: (a) activating waste coffee grounds by heat treatment at 600° C. to 1000° C. for 30 to 90 minutes in air; (b) pulverizing the activated waste coffee grounds for 15 to 20 hours; and (c) mixing the pulverized waste coffee grounds with a solvent and a binder to manufacture an electrode.

In step (c), the solvent may be one selected from among dimethylformamide, diethylformamide, N-methyl-2-pyrrolidone, dimethyl sulfoxide, dimethylacetamide, isopropyl alcohol, and a mixture thereof; the binder may be one selected from among polyvinylidene fluoride, polytetrafluoroethylene, poly(vinyl)alcohol, polyethylene, and a mixture thereof; and a weight ratio of the pulverized waste coffee grounds to the binder may range from 1:8 to 1:10.

According to the present invention, it is possible to provide a capacitive deionization electrode which includes activated waste coffee grounds having a large specific surface area and an appropriate pore size distribution, and a method of manufacturing the same.

In addition, it is possible to provide a water-treatment apparatus which includes the capacitive deionization electrode including activated waste coffee grounds according to the invention, thereby exhibiting improved adsorption/desorption capacity/rate and thus excellent ion removal efficiency.

A capacitive desalination system can efficiently remove ions from a liquid even at a relatively low potential of 1.5 V or less without generation of secondary contaminants and thus is regarded as future water-treatment technology. Although global coffee consumption is tremendous, the high added value utilization of waste coffee grounds remains low. The activated waste coffee grounds according to the present invention can replace activated carbon, which is generally used in manufacture of a capacitive deionization electrode.

### BRIEF DESCRIPTION OF THE DRAWINGS

The above and other aspects, features, and advantages of the present invention will become apparent from the detailed description of the following embodiments in conjunction with the accompanying drawings, in which;

FIG. 1 is a schematic view of a typical deionization apparatus (for example, a capacitive deionization apparatus);

FIG. 2 is a view illustrating a process of producing activated waste coffee grounds in Preparative Examples 1-1 and 1-2;

FIG. 3 is an image comparing surface particle homogeneity between a capacitive deionization electrode including activated waste coffee grounds produced in Example 1 and a capacitive deionization electrode including non-activated waste coffee grounds produced in Comparative Example 1;

FIG. 4 is an image of a capacitive deionization water-treatment stack including the capacitive deionization electrode including activated waste coffee grounds produced in Example 1;

FIG. 5 shows cyclic voltammetry graphs of a typical capacitive deionization electrode manufactured using activated carbon (P-60) of Comparative Example 2 and the capacitive deionization electrode including activated waste coffee grounds of Example 1; and

FIG. 6 is a graph comparing ion removal efficiency between the capacitive deionization electrode including activated waste coffee grounds of Example 1 and the typical capacitive deionization electrode manufactured using activated carbon (P-60) of Comparative Example 2 when hard water-treatment was performed using stack cells including the electrodes.

### DETAILED DESCRIPTION

Hereinafter, various aspects and exemplary embodiments of the present invention will be described in detail.

In accordance with one aspect of the present invention, there is provided a capacitive deionization electrode including waste coffee grounds. The capacitive deionization electrode including waste coffee grounds according to the present invention uses waste coffee grounds as an electrode material instead of activated carbon, which is generally used in manufacture of a typical capacitive deionization electrode for water treatment, thereby improving economic feasibility.

The waste coffee grounds may be heat-treated waste coffee grounds. According to the present invention, the capacitive deionization electrode includes waste coffee grounds activated by heat treatment, thereby exhibiting improved adsorption/desorption efficiency.

Here, heat treatment may be performed at 600° C. to 1000° C. for 30 to 90 minutes in air. Particularly, it was confirmed that the waste coffee grounds subjected to activation at 600° C. to 1000° C. for 30 to 90 minutes in air were sufficiently effective in improving adsorption/desorption efficiency of the capacitive deionization electrode to replace typical activated carbon. In addition, it could be seen that, when the activation temperature was less than 600° C., the waste coffee grounds were not sufficiently activated and thus had considerably low specific surface area, and, when the activation temperature exceeded 1000° C., economic feasibility was reduced due to increased energy costs and the waste coffee grounds were microporous. Further, it could be see that, in the case of heat treatment at 900° C., when the activation time was less than 30 minutes, the waste coffee grounds were not sufficiently activated and thus had considerably low specific surface area, and, when the activation time exceeded 90 minutes, the waste coffee grounds were microporous. More preferably, activation of the waste coffee grounds may be performed at 900° C. for 90 minutes in air.

Preferably, the heat-treated waste coffee grounds have a specific surface area of 500 m²/g to 1000 m²/g and a pore size of 1 nm to 5 nm. The waste coffee grounds activated by heat treatment have a much larger specific surface area of 500 m²/g to 1000 m²/g than non-activated waste coffee grounds not subjected to heat treatment having a specific surface area of 5 m²/g or less and thus can exhibit adsorption/desorption efficiency superior or equivalent to typical activated carbon. In addition, it could be seen that the waste coffee grounds had an average pore size of 2 nm to 5 nm, i.e. were mesoporous, through activation, thereby facilitating access of ions in an electrolyte thereto.

In accordance with another aspect of the present invention, there is provided a water-treatment apparatus including the capacitive deionization electrode including the waste coffee grounds as set forth above.

In accordance with a further aspect of the present invention, there is provided a method of manufacturing a capacitive deionization electrode including activated waste coffee grounds, including: (a) activating waste coffee grounds by heat treatment at 600° C. to 1000° C. for 30 to 90 minutes in air; (b) pulverizing the activated waste coffee grounds for 15 to 20 hours; and (c) mixing the pulverized waste coffee grounds with a solvent and a binder to manufacture an electrode.

Non-activated waste coffee grounds not subjected to heat treatment have a very small specific surface area of 5 m²/g or less despite being mainly composed of carbon and thus have poor capacity to remove ions from water due to low capacitance when used in a capacitive deionization system utilizing electric double layer effects. According to the present invention, the waste coffee grounds are activated at high temperature to have increased specific surface area, thereby exhibiting improved capacity to remove ions.

In addition, it was confirmed that, when the activated waste coffee grounds were pulverized for 15 to 20 hours, surface particles could be homogenized, and homogeneity of the particles could be maintained even after the waste coffee grounds were formed into an electrode. If the pulverization time is less than 15 hours, the waste coffee grounds are not sufficiently pulverized and it is thus difficult to obtain homogenized surface particles while causing deterioration in strength of the particles. If the pulverization time exceeds 20 hours, the waste coffee grounds can exhibit low adsorption/desorption efficiency and thus poor capacitance due to cracking of surface particles when used in an electrode.

In step (c), the solvent may be one selected from among dimethylformamide, diethylformamide, N-methyl-2-pyrrolidone, dimethyl sulfoxide, dimethylacetamide, isopropyl alcohol, and a mixture thereof; the binder may be one selected from among polyvinylidene fluoride, polytetrafluoroethylene, poly(vinyl)alcohol, polyethylene, and a mixture thereof; and a weight ratio of the pulverized waste coffee grounds to the binder may range from 1:8 to 1:10. If the weight of the binder is less than the lower limit, the coffee grounds are not well agglomerated, causing deterioration in physical stability, whereas, if the weight of the binder exceeds the upper limit, an excess of the binder can block pores of the coffee grounds, causing reduction in specific surface area of the coffee grounds and increase in resistance of the electrode, thereby reducing ion-removal efficiency.

Next, the present invention will be described in more detail with reference to preparative examples and examples in conjunction with the accompanying drawings.

### Preparative Example 1-1: Preparation of Activated Waste Coffee Grounds at Different Heat-Treatment Temperatures

Waste coffee grounds were held at 400° C., 500° C., 600° C., 700° C., 800° C., 900° C., 1000° C., and 1100° C., for 90 minutes in air, thereby producing activated waste coffee grounds.

### Preparative Example 1-2: Preparation of Activated Waste Coffee Grounds Using Different Heat-Treatment Times

Waste coffee grounds in air were held at 900° C., for 10 minutes, 30 minutes, 50 minutes, 70 minutes, 90 minutes, and 110 minutes, thereby producing activated waste coffee grounds.

### Comparative Preparative Example 1

Waste coffee grounds were dried at room temperature for 24 hours, thereby preparing non-activated waste coffee grounds.

### Example 1: Manufacture of Capacitive Deionization Electrode Including Activated Waste Coffee Grounds

Among the activated waste coffee grounds prepared in Preparative Example 1-2, the activated waste coffee grounds subjected to activation for 90 minutes were pulverized for 15 hours. After a binder, polyvinylidene fluoride (PVDF), was sufficiently dissolved in a solvent, N-methyl-2-pyrrolidone, the pulverized waste coffee grounds were added in a weight ratio of the waste coffee grounds to PVDF of 1:9, followed by stirring for 10 hours, thereby preparing a slurry. The slurry was coated onto a graphite sheet to a constant thickness using a doctor blade, followed by drying at 60° C. for 5 hours, thereby manufacturing a capacitive deionization electrode.

### Comparative Example 1

A capacitive deionization electrode was manufactured in the same manner as in Example 1 except that the non-activated waste coffee grounds of Comparative Preparative Example 1 were used instead of the activated waste coffee grounds.

### Comparative Example 2

A typical capacitive deionization electrode manufactured using activated carbon (P-60) was prepared.

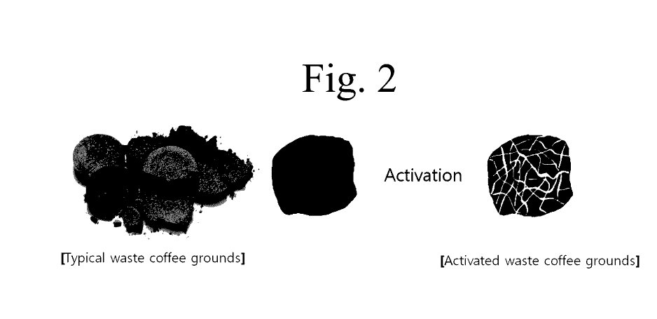

FIG. 2 is a view illustrating a process of producing activated waste coffee grounds in Preparative Examples 1-1 and 1-2 according to the present invention. As shown in FIG. 2, it can be seen that the activated waste coffee grounds obtained by heat-treating non-activated waste coffee grounds have increased porosity and increased specific surface area.

The specific surface area and average pore size of the non-activated waste coffee grounds of Comparative Preparative Example 1 and the activated waste coffee grounds of Preparative Example 1-1 were measured, and results are shown in Table 1. As shown in Table 1, it was confirmed that the waste coffee grounds prepared at a heat-treatment temperature of less than 600° C., for example, at a heat-treatment temperature of 500° C., had considerably low specific surface area, and the waste coffee grounds prepared at a heat-treatment temperature exceeding 1000° C. had considerably reduced pore diameter, i.e. became microporous. Therefore, it can be seen that it is most desirable that waste coffee grounds be heat-treated at a temperature ranging from 600° C. to 1000° C. In addition, it was confirmed that the non-activated waste coffee grounds had a specific surface area of less than 5 m²/g, whereas the specific surface area of the activated waste coffee grounds subjected to heat treatment at 900° C. was greatly increased up to 1000 m²/g.

TABLE 1

| | Comparative | | | | | | | | |
|---|---|---|---|---|---|---|---|---|---|
| | Preparative | | | | | | | | |
| | Example 1 | 400° C. | 500° C. | 600° C. | 700° C. | 800° C. | 900° C. | 1000° C. | 1100° C. |
| Specific | <5 | <150 | 200- | 500- | 600- | 700- | 800- | 800- | 800- |
| surface | | | 400 | 700 | 800 | 900 | 1000 | 1000 | 1000 |
| area | | | | | | | | | |
| (m²/g) | | | | | | | | | |
| Pore size | 0 | <10 | <10 | <5 | <5 | <5 | <2 | <1 | <0.05 |
| (nm) | | | | | | | | | |

The specific surface area and average pore size of the non-activated waste coffee grounds of Comparative Preparative Example 1 and the activated waste coffee grounds of Preparative Example 1-2 according to the present invention were measured, and results are shown in Table 2. As shown in Table 2, it was confirmed that the waste coffee grounds prepared by heat treatment for less than 30 minutes had considerably low specific surface area, and the waste coffee grounds prepared by heat treatment for more than 90 minutes had considerably reduced pore diameter, i.e. became microporous. Therefore, it can be seen that it is most desirable that waste coffee grounds be heat-treated for 30 to 90 minutes. In addition, it was confirmed that the non-activated waste coffee grounds had a specific surface area of less than 5 m²/g, whereas the specific surface area of the activated waste coffee grounds subjected to heat treatment for 90 minutes was greatly increased up to 800 m²/g to 1000 m²/g.

TABLE 2

| | Comparative | | | | | | |
|---|---|---|---|---|---|---|---|
| | Preparative | 10 | 30 | 50 | 70 | 90 | 110 |
| | Example 1 | min | min | min | min | min | min |
| Specific | <5 | 100- | 500- | 600- | 700- | 800- | 1100 |
| surface | | 300 | 600 | 700 | 800 | 1000 | |
| area | | | | | | | |
| (m²/g) | | | | | | | |
| Pore size | 0 | <25 | <15 | <10 | <4 | <2 | <1 |
| (nm) | | | | | | | |

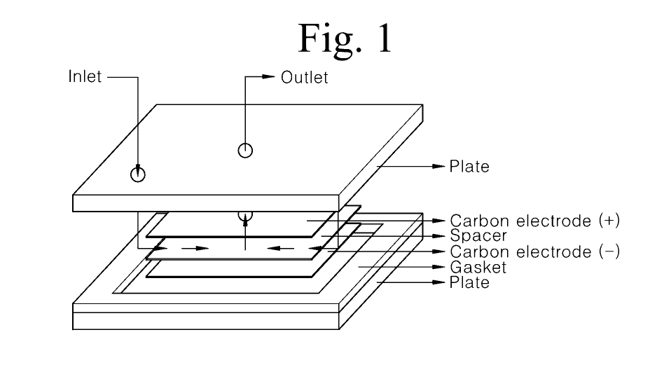

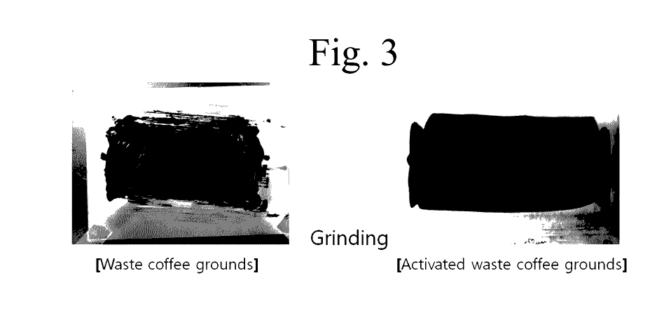

FIG. 3 is an image comparing surface particle homogeneity between the capacitive deionization electrode including the activated waste coffee grounds produced in Example 1 and the capacitive deionization electrode including the non-activated waste coffee grounds produced in Comparative Example 1. Electrodes composed of a unit cell as shown in FIG. 1 were manufactured using the activated waste coffee grounds and the non-activated waste coffee grounds as shown in FIG. 3, respectively. As a result, it was confirmed that an electrode could be more easily manufactured using the activated waste coffee grounds than using the non-activated waste coffee grounds, due to uniform flatness of the activated waste coffee grounds.

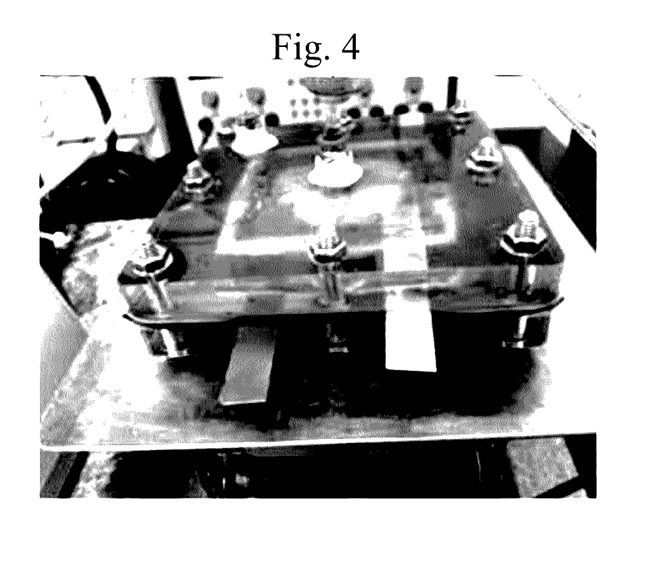

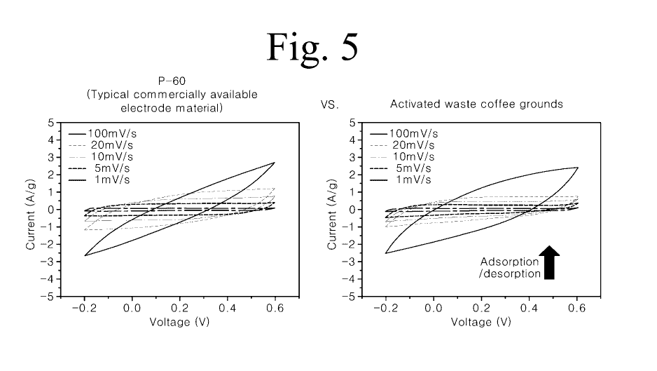

FIG. 4 is an image of a capacitive deionization water-treatment stack including the capacitive deionization electrode including the activated waste coffee grounds produced in Example 1, and FIG. 5 shows cyclic voltammetry graphs of a typical capacitive deionization electrode manufactured using activated carbon (P-60) of Comparative Example 2 and the capacitive deionization electrode including the activated waste coffee grounds of Example 1. As shown in FIG. 5, a cyclic voltammetry graph of a typical capacitive deionization electrode manufactured using activated carbon (P-60) was plotted while varying a scanning rate, and was compared with that of the capacitive deionization electrode including the activated waste coffee grounds. It was confirmed that the capacitive deionization electrode including the activated waste coffee grounds exhibited an increased adsorption/desorption rate as compared with the typical capacitive deionization electrode manufactured using activated carbon (P-60).

Capacitance of each of the typical capacitive deionization electrodes manufactured using activated carbon (P-60) of Comparative Example 2 and the capacitive deionization electrode including the activated waste coffee grounds of Example 1 was measured at different scanning rates, and results are shown in Table 3. As shown in Table 3, it can be seen that the capacitive deionization electrode of Example 1 exhibited considerably high adsorption efficiency even at a high scanning rate of 100 mV/S. In addition, it can be seen that the capacitance of the electrode including the activated waste coffee grounds was increased overall by 30% or more, as compared with the typical electrode manufactured using activated carbon.

TABLE 3

| | (F/g) | | | | |
|---|---|---|---|---|---|
| | 100 | 20 | 10 | 5 | 1 |
| | mV/s | mV/s | mV/s | mV/s | mV/s |
| Comparative | 7 | 20 | 35 | 40 | 50 |
| Example 2 | | | | | |
| Example 1 | 30 | 35 | 40 | 50 | 60 |

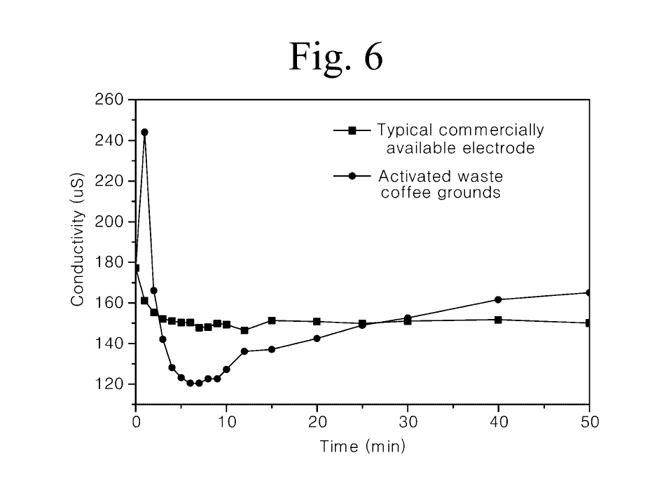

FIG. 6 is a graph comparing ion removal efficiency between the capacitive deionization electrode including the activated waste coffee grounds of Example 1 and the typical capacitive deionization electrode manufactured using activated carbon (P-60) of Comparative Example 2 when hard water-treatment was performed using stack cells including the electrodes. As shown in the graph, it was confirmed that the capacitive deionization electrode including the activated waste coffee grounds exhibited better ion-adsorption efficiency and a higher ion removal rate than the typical capacitive deionization electrode manufactured using activated carbon. Referring to FIG. 6, it can be seen that the ion removal rate of the electrode including the activated waste coffee grounds was increased by 30% as compared with the typical electrode manufactured using activated carbon.

Therefore, according to the present invention, it is possible to provide a capacitive deionization electrode including activated waste coffee grounds having a large specific surface area and an appropriate pore size distribution, and a method of manufacturing the same. In addition, it is possible to provide a water-treatment apparatus which includes the capacitive deionization electrode including activated waste coffee grounds, thereby exhibiting improved adsorption/desorption capacity/rate and thus excellent ion removal efficiency. As described above, it was confirmed that the performance of the capacitive deionization electrode according to the present invention was superior or equivalent to a typical capacitive deionization electrode.

What is claimed is:

1. A capacitive deionization electrode comprising waste coffee grounds.

2. The capacitive deionization electrode according to claim 1, wherein the waste coffee grounds are heat-treated waste coffee grounds.

3. The capacitive deionization electrode according to claim 2, wherein heat treatment is performed at 600° C. to 1000° C. for 30 to 90 minutes in air.

4. The capacitive deionization electrode according to claim 1, wherein the heat-treated waste coffee grounds have a specific surface area of 500 m²/g to 1000 m²/g and a pore size of 1 nm to 5 nm.

5. A water treatment apparatus comprising the capacitive deionization electrode comprising waste coffee grounds according to claim 1.

6. A method of manufacturing a capacitive deionization electrode comprising activated waste coffee grounds, comprising:
(a) activating waste coffee grounds by heat treatment at 600° C. to 1000° C. for 30 to 90 minutes in air;
(b) pulverizing the activated waste coffee grounds for 15 to 20 hours; and
(c) mixing the pulverized waste coffee grounds with a solvent and a binder to manufacture an electrode.

7. The method according to claim 6, wherein, in step (c), the solvent is one selected from among dimethylformamide, diethylformamide, N-methyl-2-pyrrolidone, dimethyl sulfoxide, dimethylacetamide, isopropyl alcohol, and a mixture thereof; the binder is one selected from among polyvinylidene fluoride, polytetrafluoroethylene, poly(vinyl)alcohol, polyethylene, and a mixture thereof; and a weight ratio of the pulverized waste coffee grounds to the binder ranges from 1:8 to 1:10.
